(19) United States
(12) Patent Application Publication
(10) Pub. No.: US 2020/0298059 A1
(43) Pub. Date: Sep. 24, 2020

(54) Methods, Systems, and Apparatus for Physically Active Work-driven Gaming

(71) Applicant: James P Janniello, Sarasota, FL (US)

(72) Inventor: James P Janniello, Sarasota, FL (US)

(21) Appl. No.: 16/894,090

(22) Filed: Jun. 5, 2020

Related U.S. Application Data
(63) Continuation-in-part of application No. 14/535,123, filed on Nov. 6, 2014.
(60) Provisional application No. 62/921,276, filed on Jun. 7, 2019.

(51) Int. Cl. A63B 24/00; A63F 9/18; G07F 17/32

(52) U.S. Cl. CPC A63B 24/0059; A63B 24/0006; A63F 9/183; A63F 2009/186; G07F 17/3267; A63B 2024/0015; G07F 17/3295

(57) ABSTRACT

Methods, systems, and apparatus for performing a work-driven game are described. An indication of a completion of a performance of a work event is obtained from a work processing system, the work event contributing to a production of a work product. A completion of a performance of an exercise event is obtained from an exercise machine. A combined value of the work event and the exercise event is determined and a gaming asset associated with the work-driven game is awarded in a game processing system in response to the indication of the completion of the performance of the work event and the completion of the performance of the exercise event, the gaming asset awarded being based on the combined value.

### CLAIM OF PRIORITY

This application claims the benefit of priority under 35 U.S.C. § 119(e) of U.S. Provisional Patent Application Ser. No. 62/921,276, filed on Jun. 7, 2019, and is a continuation-in-part of U.S. patent application Ser. No. 14/535,123, filed on Nov. 6, 2014, which are incorporated by reference herein in their entirety.

### TECHNICAL FIELD

The present application relates generally to exercise equipment and electronic gaming, and more specifically, in one example, to driving gaming activity based on events, including work activities and tasks, work results, work status, exercise activities, exercise results, and the like.

### BACKGROUND

Electronic gaming often involves players who control certain gaming activities and a gaming processor that controls other gaming activities. The gaming processor may manage the state of the game, the state of active players and, optionally, the state of inactive players. The various states may be used to determine a game event(s) and/or new states of the player(s) and the game. A player's gaming activity may be measured based on skill, dexterity, knowledge, and the like.

Electronic gaming is often driven by inputs received from a game player. For example, a joystick, an electronic mouse, a camera, a microphone, a controller, and the like may be used to gather input information from a player. The input information may be visual information, motion information, audio information, speech information, text information, and the like. Based on the input generated by the player, the player may be awarded a gaming asset, may initiate a gaming action, and/or may achieve a gaming objective.

### BRIEF DESCRIPTION OF THE DRAWINGS

Some embodiments are illustrated by way of example and not limitation in the figures of the accompanying drawings in which:

FIG. 1 is a block diagram of an example system, in accordance with an example embodiment, for performing work-driven gaming;

FIG. 2 is a block diagram of an example apparatus, in accordance with an example embodiment, for performing work-driven gaming;

FIG. 3A is a representation of an example rule base comprising one or more rules for determining a gaming event for a work-driven gaming environment, in accordance with an example embodiment;

FIG. 3B is a representation of an example class table comprising one or more classes of awards for a work-driven gaming environment, in accordance with an example embodiment;

FIG. 3C is a representation of an example table illustrating a mapping of an award to gaming input for a work-driven gaming environment, in accordance with an example embodiment;

FIG. 4 is a flowchart for an example work-driven gaming method, in accordance with an example embodiment;

FIG. 5A is a flowchart for an example work interface method, in accordance with an example embodiment;

FIG. 5B is a flowchart for an example exercise interface method, in accordance with an example embodiment;

FIG. 6 is a representation of an example user interface for performing a phrase guessing game, in accordance with an example embodiment;

FIG. 7 is a flowchart for an example gaming method, in accordance with an example embodiment;

FIG. 8 is a flowchart for an example user interface method for performing a phrase guessing game, in accordance with an example embodiment; and

FIG. 9 is a block diagram of machine within which instructions may be executed for causing the machine to perform any one or more of the methodologies discussed herein.

### DETAILED DESCRIPTION

In the following detailed description of example embodiments, reference is made to specific examples by way of drawings and illustrations. These examples are described in sufficient detail to enable those skilled in the art to practice these example embodiments, and serve to illustrate how the invention may be applied to various purposes or embodiments. Other embodiments of the invention exist and are within the scope of the invention, and logical, mechanical, electrical, and other changes may be made without departing from the scope or extent of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Generally, methods, systems, and apparatus for performing work-driven gaming are described. In one example embodiment, a work event, such as a work result, a completion of a work task, a change in status of a work item, and the like; an exercise event, such as jogging on a treadmill, lifting weights, standing at a desk, and the like; or a combination thereof may result in awarding a gaming asset to a worker or a team of workers. As used herein, an “event” refers to a work event, an exercise event, a combination of work event and exercise event, and the like. As used herein, a “gaming asset” may comprise a virtual asset, a clue, an action within a gaming environment, an input to a gaming environment, an advancement to another level in a game, an action of an avatar, and the like. The gaming asset, such as the advancement to another level in a game, may be obtained, for example, by generating gaming input to the gaming environment on behalf of the player. In one example embodiment, the gaming input generated on behalf of the player may be submitted, for example, to a conventional electronic game. For example, the gaming input may be submitted via an interface conventionally used for interfacing to a keyboard, a mouse, a joystick, a camera, a controller, and the like. Each game may be designed for players who are employees or other workers in order to drive employee engagement, motivation, and communication among players. Each gaming solution provides employees with a gaming environment driven, in part, by their work accomplishments and exercise accomplishments.

As used herein, a work event may be a work result, a completion of a work task, a change in status of a work item, a meeting or an exceeding of one or more of a sales goal, a work safety goal, a quality goal, a customer satisfaction goal, an external recognition goal, a production goal, and the like. As used herein, an exercise event may be an exercise result, a completion of an exercise, a meeting or an exceeding of an exercise goal, an external exercise recognition goal, and the like.

Games that may be work-driven include games of skill, games of chance, games of intellect, and the like. As used herein, a “work-driven” game is a game that is driven partially or completely based on work events, exercise events, a combination of work events and exercise events, and the like.

In one example embodiment, a phrase guessing game may be work-driven. A player may be presented with the structure of a phrase or sentence, as described more fully below, and the user may attempt to guess the correct phrase. A goal of the game may be to correctly guess the phrase in the shortest amount of time. The user may be awarded, for example, one or more letters of the phrase in response to an event.

In one example embodiment, a conventional phrase guessing game may be transformed into a work-driven game. A work-driven gaming apparatus may input one or more correct letters into the conventional phrase guessing game on behalf of the player in response to an event. For example, the completion of a work task may result in the entry of two letters in the phrase guessing game by the work-driven gaming apparatus via a keyboard interface of a conventional phrase guessing game.

In one example embodiment, a mountain climbing game may be work-driven. The goal may be for the user to reach the summit of a mountain in the shortest amount of time. The player may be awarded a certain level, such as reaching a base camp, or may be awarded an action, such as an avatar jumping to a higher ledge on the mountain, in response to a combination of work event and exercise event.

Each award may be characterized by its particular value to the game. In one example embodiment, awards may be categorized into classes based on their value, where each class contains awards corresponding to a particular value range. For example, each class may be labeled by a letter, such as “A”, “B”, “C”, and the like, where each letter corresponds to a particular value range. In one example embodiment, an award for a particular event is selected from an award class that is commensurate with the value of the event.

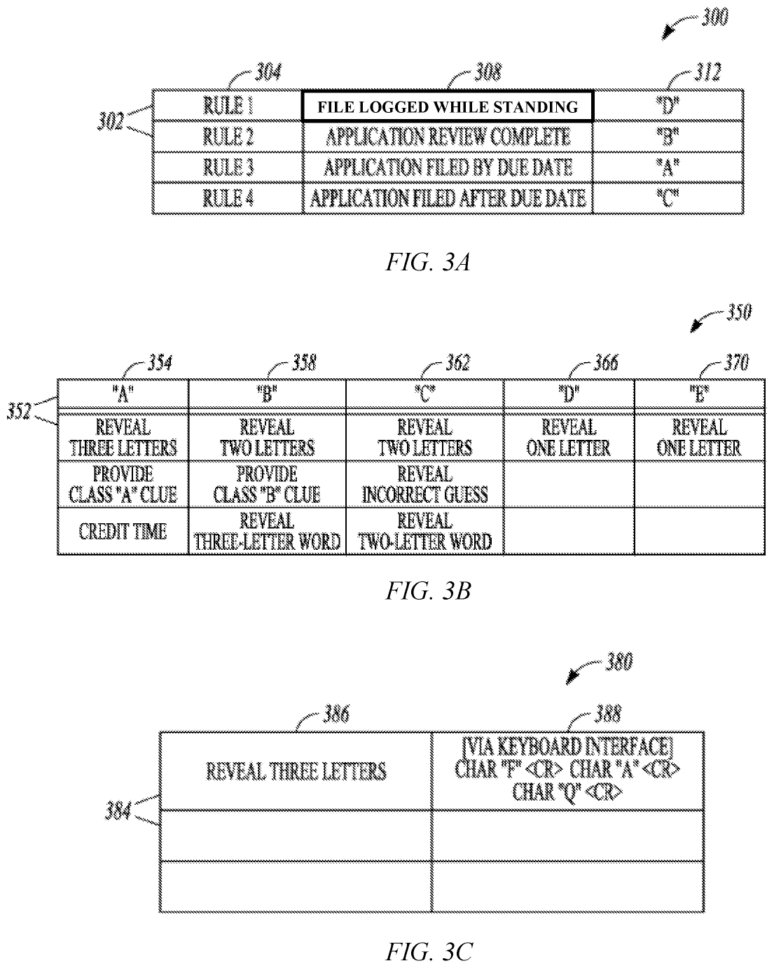

In one example embodiment, different types of events are normalized in terms of value in order to fairly award assets based on the difficulty of the event, the time required to complete the event, the level of results achieved, the probability of successfully completing the event, and the like. These criteria, such as the time required to perform the event and the probability of success, may be used to normalize the awards that are granted based on the normalized value of the event. For example, successful completion of an event that is normally successful 65% of the time would result in a more valuable asset being awarded than an event that is normally successful 95% of the time. In one non-limiting example, the value of the asset is inversely proportional to the probability of successfully completing the event. Successful completion of an event that requires three hours would result, for example, in a more valuable asset being awarded than an event that is completed in one hour. In one non-limiting example, the value of the asset is proportional to the time required for completing the event. Successful completion of an event that required 60% of the normal time to complete the event would result, for example, in a more valuable asset being awarded than an event that required 90% of the normal time to complete the event. The normal time to complete the event may be based on a group of users or may be based solely on the normal time to complete the event by the player. In one non-limiting example, the value of the asset is inversely proportional to the time required to complete the event in relation to the normal time required for completing the event. Successful completion of an event that has an equivalent cash value of $10,000, for example, would result in a more valuable asset being awarded than an event that has an equivalent cash value of $3,000. In one non-limiting example, the value of the asset is proportional to the cash value. Successful completion of an event ahead of schedule would, for example, result in a more valuable asset being awarded than an event that is completed late. In one non-limiting example, the value of the asset is proportional to the calories burned in completing an exercise event. For example, an exercise event that burns more calories may result a more valuable asset being awarded than an exercise event that burns less calories. A gaming administrator may define the conditions that constitute the event as well as the assets that are awarded for completing each class or type of event. For example, a rule base may be used to define the conditions that constitute the event as well as the assets that are awarded for completing each class or type of event, as described more fully below in conjunction with FIG. 3A.

In one example embodiment, an exercise machine assists a user in performing physical activities, such as aerobic exercises, strength building exercises, and the like. The exercise machine reports results of the exercise (also referred to as an exercise event herein), such as results achieved by a user of the exercise equipment, an achievement of an exercise goal, and the like. For example, a treadmill may report an amount of time that a user was walking, jogging, running, and the like; an average speed of the user; reaching an achievement level, such as running three miles over a thirty-minute period; an achieved biometric goal (such as an achieved pulse rate goal), and the like. In one example embodiment, a gaming asset is awarded if the performance of the exercise event occurs during the performance of a work event. In one example embodiment, the specific gaming asset awarded is based on the exercise event. In one example embodiment, the specific gaming asset awarded is based on the combination of an exercise event(s) and a work event(s). For example, performing a work task while standing at a desk for 40 minutes may result in the awarding of an award commensurate with the combined exercise event(s) and work event(s).

As described above, successfully completed events generate gaming assets within the gaming environment. In one example embodiment, an accumulation of one or more gaming assets is necessary to start and/or continue game play. Thus, game play may be automatically regulated by productivity in terms of work and/or exercise.

In one example embodiment, game play may be disabled when a particular type of gaming asset is not in the user's inventory of assets, when a particular quantity of one or more types of gaming assets is not in the user's inventory of assets, during the performance of selected events, and the like. For example, game play may be suspended during the performance of a critical work event, during the performance of a work event that requires a high degree of concentration, and the like. To disable game play, the user interface for the game may be hidden from the user, or the user interface may be exposed to the user but with a set of gaming functions being inaccessible or otherwise disabled. Similarly, the gaming user interface may be disabled or hidden during certain times of day or during the performance of selected events. The selected events may be defined by the user, an administrator, and the like.

In one example embodiment, access to a gaming user interface is enabled and disabled by the status of an event(s). For example, a user interface may be provided when a particular event is started or completed, and may be disabled upon the start or completion of another event or the same event. A task that comprises a plurality of events may also be used to award gaming assets, enable game play, and the like. For example, a task may comprise a set of work events and exercise events, and a gaming asset may be awarded when a particular set or subset of the events that comprise the task is completed.

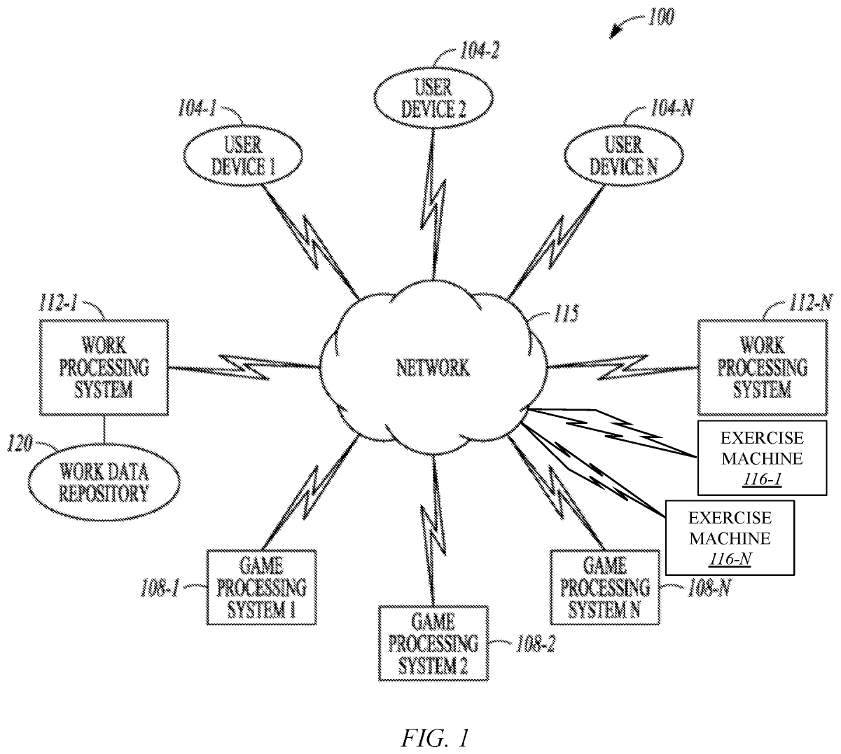

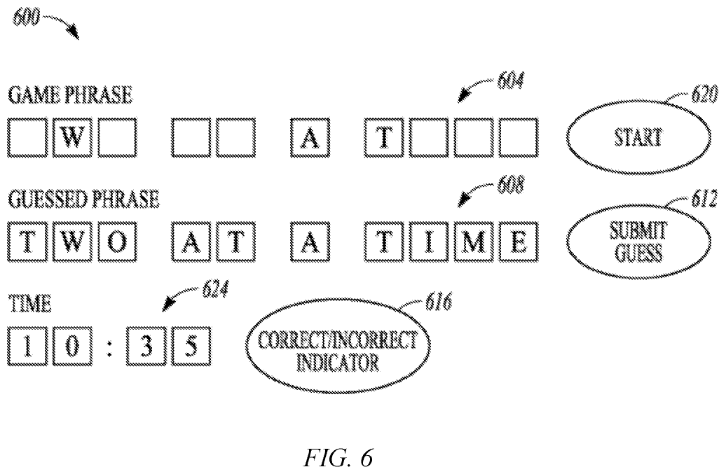

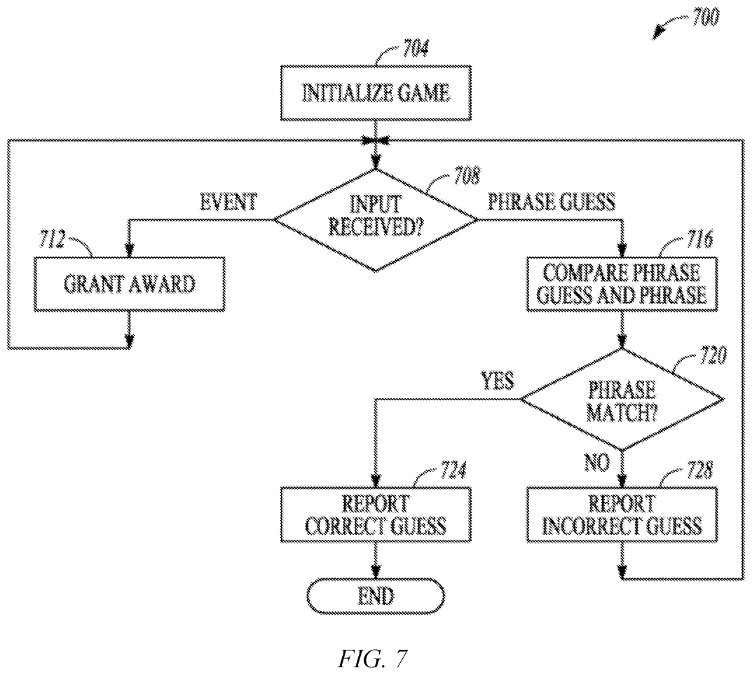

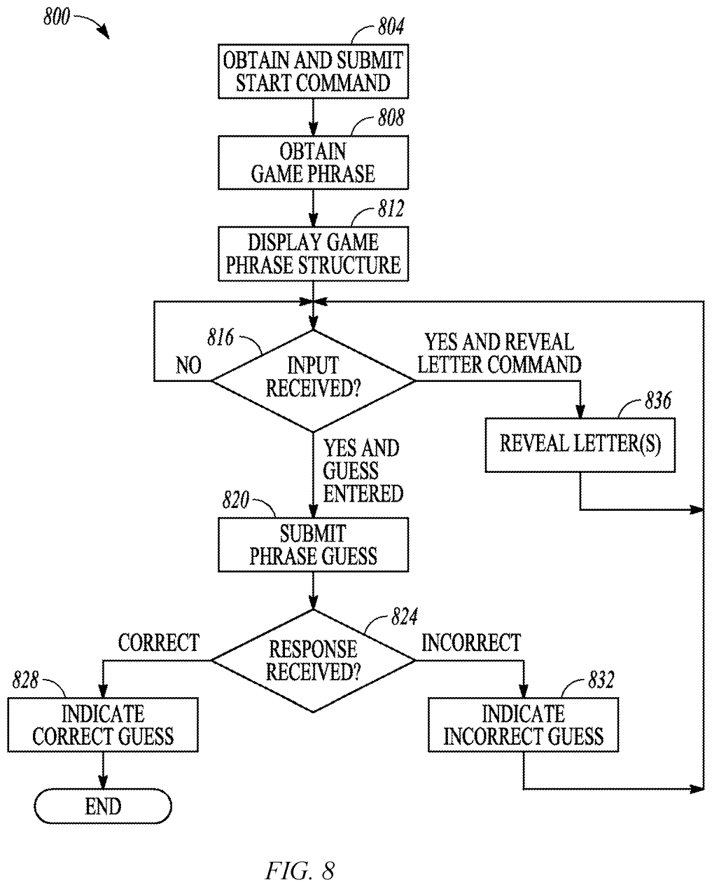

FIG. 1 is a block diagram of an example system 100 for performing work-driven gaming, in accordance with an example embodiment. In one example embodiment, the system 100 may comprise one or more user devices 104-1, 104-2 and 104-N (known as user devices 104 hereinafter), one or more work processing systems 112-1 through 112-N (known as work processing systems 112 hereinafter), one or more game processing systems 108-1, 108-2 and 108-N (known as game processing systems 108 hereinafter), one or more exercise machines 116-1 through 116-N (known as exercise machines 116 hereinafter), and a network 115. Each user device (e.g., 104-1) may be a personal computer (PC), a tablet computer, a mobile phone, a personal digital assistant (PDA), a wearable computing device (e.g., a smartwatch), or any other appropriate computer device. Each user device (104-1, 104-2 or 104-N) may include a user interface processing module for providing a user interface, described more fully below in conjunction with FIGS. 6 and 8. In one embodiment, the user interface processing module may comprise a web browser program. Although a detailed description is only illustrated for user device 104-1, it is noted that each of the other user devices (e.g., user device 104-2 through user device 104-N) may have corresponding elements with the same functionality.

The work processing systems 112 collaborate with a user or group of users in performing work related tasks. For example, the work processing system 112-1 may be a legal docketing application for managing legal cases. The legal docketing application may maintain a status for each legal case including, for example, pending work items, due dates for work items, and a status for each work item.

The game processing systems 108 may be informed of and/or detect an event, such as an update to a status of a work item, a change in a status of a work item, a milestone for a work item, a completion of an exercise, and the like. In response to being informed of an event, the game processing systems 108 may, for example, award a gaming asset to the user or group of users associated with the event.

The exercise machines 116 provide for a variety of exercises, such as strength building exercises, weight lifting, aerobics, standing while working (using, for example, a standing desk), and the like. The exercise machines 116 provide reports on exercise events via network 115. A user may physically interact with the exercise machine 116 during the exercise, such as jogging on a treadmill, may be monitored by the exercise machine 116, such as being timed while jogging by a smartphone or smartwatch, or both. In one example embodiment, the exercise machines 116 include a processor and network interface to provide the reports via network 115. In one example embodiment, a non-limiting exercise machine 116 comprises an intelligent exercise monitor that monitors exercise activity using the exercise machine 116 and generates a report via network 115. In one example embodiment, a non-limiting exercise machine 116 comprises an intelligent exercise monitor that monitors exercise activity, such as stretching, running, and the like, that can be performed without the physical assistance of a machine. For example, a smartwatch or smartphone may monitor a distance jogged by an individual and may monitor the individual's pulse rate to characterize an aerobic exercise. The smartwatch or smartphone may then generate a report via network 115.

The network 115 may be a local area network (LAN), a wireless network, a metropolitan area network (MAN), a wide area network (WAN), a wireless network, a network of interconnected networks, the public switched telephone network (PSTN), and the like.

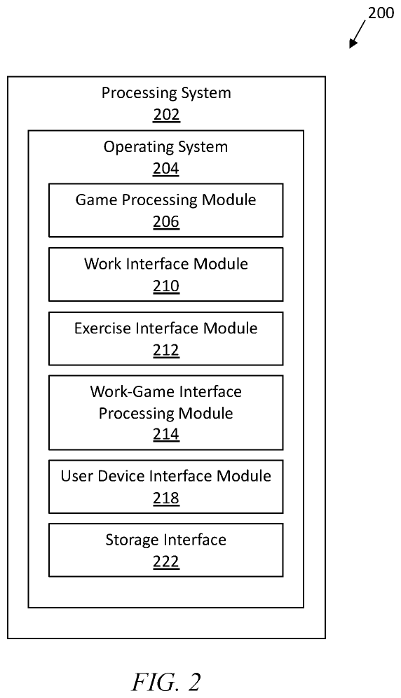

FIG. 2 is a block diagram of an example apparatus 200, in accordance with an example embodiment, for performing work-driven gaming. The apparatus 200 is shown to include a processing system 202 that may be implemented on a client or other processing device that includes an operating system 204 for executing software instructions.

In accordance with an example embodiment, the apparatus 200 may include a game processing module 206, a work interface module 210, an exercise interface module 212, a work-game interface processing module 214, and a user device interface module 218. In accordance with an example embodiment, the apparatus 200 may further include a storage interface 222.

The work interface module 210 may provide information on work events to, for example, the work-game interface processing module 214. The work interface module 210 may obtain the work events from a wide variety of conventional work-based systems and databases, including inventory applications, sales management systems, manufacturing systems, web-based applications, and the like.

The exercise interface module 212 provides information on exercise events to, for example, the work-game interface processing module 214. The exercise interface module 212 obtains the exercise events from the exercise machines 116, the user device 104, and the like.

The user device interface module 218 may obtain events logged by a user or administrator, and may obtain events detected by the user device 104 while a user conducts conventional work and/or exercise activities. For example, the user device 104 may detect the completion of a sale by a salesperson, and the corresponding work event detected by the user device 104 may be transferred to the user device interface module 218. For example, the user device 104 may detect the completion of an exercise by an individual, and the corresponding exercise event detected by the user device 104 may be transferred to the user device interface module 218. The user device interface module 218 may provide information on events to game processing module 206 and/or to work-game interface processing module 214.

The work-game interface processing module 214 may obtain work event information from the work interface module 210, exercise event information from the exercise interface module 212, and/or event information from the user device interface module 218, and may generate gaming input for the game processing module 206 based on the obtained work event information, the exercise event information, or both. In one example embodiment, the work-game interface processing module 214 may generate the gaming input by mapping and/or translating a work event, an exercise event, or both to gaming input. As described more fully above, the gaming input may be input signals that emulate an input device, such as a keyboard, a mouse, a joystick, a camera, a controller, and the like, and may be generated for a conventional gaming environment on behalf of the player. The gaming input may be transferred to the conventional gaming environment via one or more interfaces on the conventional gaming environment. Interfaces include, but are not limited to, a keyboard interface, a mouse interface, a joystick interface, a camera interface, a controller interface, and the like.

The game processing module 206 may obtain gaming input from the work-game interface processing module 214 and/or the user device interface module 218, and may generate a gaming environment for a user or team of users.

In one example embodiment, the game processing module 206 may generate gaming input for a conventional gaming environment on behalf of a player. For example, the game processing module 206 may enter one or more letters of a phrase guessing game into a conventional phrase guessing game on behalf of the user. The gaming input may be submitted to the conventional phrase guessing game via a custom interface or via an existing interface on the conventional game.

The game processing module 206 may be preconfigured with the appropriate input for a conventional game. In one example embodiment, the game processing module 206 may learn the appropriate input called for by a conventional game by tracking earlier game playing sessions. For example, the gaming processing module 206 may track the input to and output from the conventional game to learn the structure of the input and/or the output used by the conventional game. In one example embodiment, the game processing module 206 may map a work event, an exercise event, a combination of work event and exercise event, or a gaming asset to the appropriate structure for gaming input for a conventional game.

In one example embodiment, the game processing module 206 normalizes the value of a work event, an exercise event, or both and may determine an asset to award based on the normalized value, as described herein. For example, as described below in conjunction with FIG. 3A, a rule may specify a table or formula for normalizing the value of a work event, an exercise event, a combination of work event and an exercise event based on the type or class of work event, exercise event, or both and for determining the class of asset to be awarded.

FIG. 3A is a representation of an example rule base 300 comprising one or more rules that may be statically or dynamically used to determine a class of an award for a work-driven gaming environment, in accordance with an example embodiment. Each row 302 of the rule base 300 may correspond to one rule. Column 304 may comprise a rule identifier, column 308 may comprise the condition for applying the corresponding rule, and column 312 may comprise a class for an award. Example conditions may be based on one or more of: 1) an occurrence of a work event; 2) a status of a work item; 3) a change in status of a work item; 4) a milestone for a work item; 5) a meeting or an exceeding of one or more of a sales goal, a work safety goal, a quality goal, a customer satisfaction goal, an external recognition goal, a production goal; 6) a type or class of work event; 7) an occurrence of an exercise event; 8) a type or class of an exercise event; and the like. Example awards may comprise a gaming asset, such as a virtual asset, a clue, an action within a gaming environment, an input to a gaming environment, an advancement to another level in a game, an action of an avatar, and the like. For example, a rule of the rule base 300 may indicate that the value of the asset is inversely proportional to the probability of successfully completing the event, where a class A asset is awarded for a successfully completed event that has a 1-25% probability of success, a class B asset is awarded for a successfully completed event that has a 26-50% probability of success, a class C asset is awarded for a successfully completed event that has a 51-75% probability of success, and a class D asset is awarded for a successfully completed event that has a 76-100% probability of success.

A rule of the rule base 300 may indicate that the value of the asset is inversely proportional to the time required to complete the event (the work event, the exercise event, or a combination of the work event and exercise event) in relation to the normal time required for completing the event, where a class A asset is awarded for a successfully completed event that is completed within 1-25% of the average time to successfully complete the event, a class B asset is awarded for a successfully completed event that is completed within 25-75% of the average time to successfully complete the event, a class C asset is awarded for a successfully completed event that is completed within 76-125% of the average time to successfully complete the event, and a class D asset is awarded for a successfully completed event that is completed within 126-200% of the average time to successfully complete the event. In this example, no asset is awarded for an event that required more than 200% of the average time to successfully complete.

A rule of the rule base 300 may indicate that the value of the asset is proportional to the cash value of the event, where a class A asset is awarded for a successfully completed event that has a value greater than $10,000, a class B asset is awarded for a successfully completed event that has a value of between $5,000 and $9,999, a class C asset is awarded for a successfully completed event that has a value between $2,500 and $4,999, and a class D asset is awarded for a successfully completed event that has a value less than $2,500.

FIG. 3B is a representation of an example class table 350 comprising one or more classes for awards for a work-driven gaming environment, in accordance with an example embodiment. Each column 354, 358, 362, 366, 370 of the class table 350 may correspond to a class of award. Column 354 may comprise one or more class “A” awards, column 358 may comprise one or more class “B” awards, column 362 may comprise one or more class “C” awards, column 366 may comprise one or more class “D” awards, and column 370 may comprise one or more class “E” awards.

FIG. 3C is a representation of an example table 380 illustrating a mapping of an award to gaming input for a work-driven gaming environment, in accordance with an example embodiment. Each row 384 may correspond to an award. Column 386 may comprise an identifier of the corresponding award and column 388 may comprise one or more gaming inputs for granting the award.

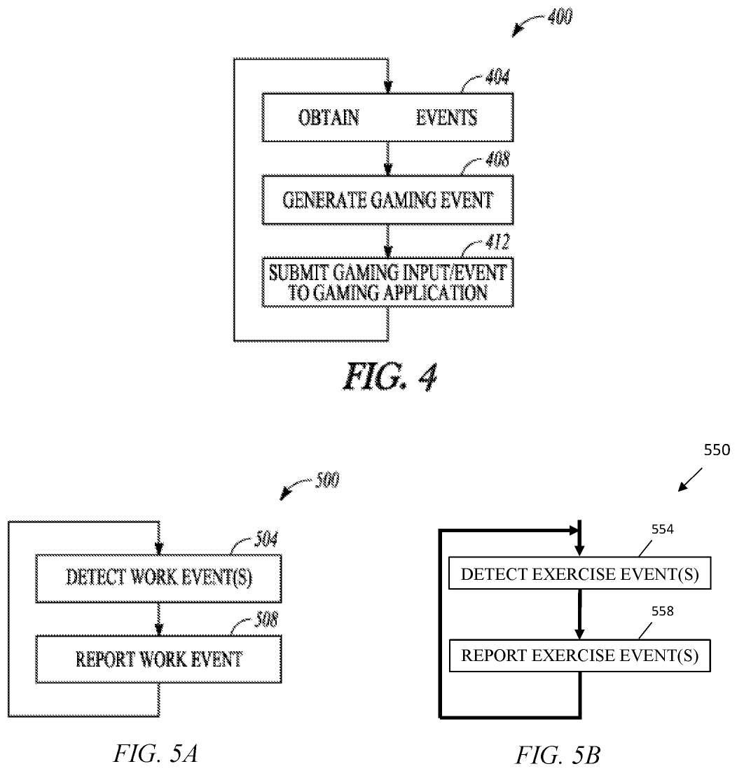

FIG. 4 is a flowchart for an example work-driven gaming method 400, in accordance with an example embodiment. In one example embodiment, the work-driven gaming method 400 may be performed by the work-game interface processing module 214.

One or more events may be obtained (operation 404). The event may be obtained, for example, from the user device interface module 218, the work interface module 210, the exercise interface module 212, or any combination thereof. For example, a user may update a status of a pending case in a legal docketing application via the user device 104-1. The user device 104-1 may submit a work event to the work-game interface processing module 214 based on the status update. The work event may be submitted to the work-game interface processing module 214 at the request of the user or automatically by the user device 104-1.

In one example embodiment, a salesperson may meet a sales goal and a work event may be submitted to the work-game interface processing module 214. The work event may be submitted by the work interface module 210 and may be submitted at the request of a user. In one example embodiment, the work event may be detected by the work interface module 210 and may be automatically submitted by the work interface module 210. In one example embodiment, an exercise event may be detected by the exercise interface module 212 and may be automatically submitted by the exercise interface module 212.

For each obtained event, a gaming event may be generated (operation 408). The gaming event may be the awarding of a gaming asset and/or the generation of gaming input. In one example embodiment, an event may be translated into a gaming award. For example, a formula may be used to determine a gaming award based on an amount of time working at a standing desk while logging invoices in a work processing system 112; or an amount of sales by a salesperson for a specific time period, such as a day, week and/or month. In one example embodiment, the class of an award is proportional to an amount of time working at a standing desk while logging invoices in a work processing system 112; or an amount of sales by a salesperson.

In one example embodiment, a rule base may be used to determine the class of the gaming award. For example, a rule may indicate that a class “B” gaming asset is to be awarded to each member of a sales team that meets or exceeds a monthly goal. In another example, a user may be awarded a class “C” asset for updating a status of a pending legal case by a prescribed deadline. In another example, a user may be awarded a class “A” asset for standing for thirty minutes at desk while logging invoices.

A generated gaming event and/or gaming input may be submitted to a gaming application (operation 412) and the method may proceed to operation 404. For example, a gaming input indicating that an award should be presented to a user may be submitted to the game processing module 206. In one example embodiment, gaming input may be submitted to a conventional gaming environment via the game processing module 206. For example, a gaming input indicating that an award should be presented to a user may be submitted to a conventional gaming environment.

In one example embodiment, the gaming input may be generated by mapping and/or translating an event to a gaming event. The mapping may be based on the rule base described more fully above in conjunction with FIG. 3A.

FIG. 5A is a flowchart for an example work interface method 500, in accordance with an example embodiment. In one example embodiment, the work interface method 500 may be performed by the work interface module 210.

One or more work events may be detected (operation 504). The work event may be detected, for example, by monitoring various systems, applications, and communications among systems and users. For example, electronic mail may be monitored to identify a project milestone. An inventory database may be monitored to detect an achievement of a productivity goal. A legal docketing application may be monitored to detect the updating of a status of a case or a filing of a legal brief.

The detected work event(s) may be reported to a gaming application (operation 508). For example, the detected work event(s) may be reported to the work-driven gaming method 400.

FIG. 5B is a flowchart for an example exercise interface method 550, in accordance with an example embodiment. In one example embodiment, the exercise interface method 500 may be performed by the exercise interface module 212.

One or more exercise events are detected (operation 504). For example, an exercise machine 116 may report the meeting of a running goal by a user. The detected exercise event(s) are reported to a gaming application (operation 508). For example, the detected exercise event(s) may be reported to the work-driven gaming method 400.

FIG. 6 is an example representation of a user interface 600 for performing a phrase guessing game, in accordance with an example embodiment. A mobile device may provide the user interface 600, for example. A game may be started by selecting the “start” radio button 620. A structure of a phrase to be guessed may be displayed in phrase display area 604. The structure may indicate the number of words in the phrase and the number of letters in each word. As letters are revealed, the block representing the corresponding letter may be replaced with the corresponding letter.

A user may enter a guess of the phrase in phrase input field 608. Once a phrase has been entered in the phrase input field 608, the user may select the “submit guess” radio button 612 to submit the phrase guess. A “correct or incorrect” guess indicator 616 may indicate whether the guess is correct or incorrect.

During a game, a timer field 624 may indicate the amount of elapsed time since the start of the game. Once the phrase has been correctly guessed, the timer field 624 may indicate the amount of time used to complete the game.

FIG. 7 is a flowchart for an example gaming method 700, in accordance with an example embodiment. In one example embodiment, the gaming method 700 may be performed by the game processing module 206. In one example embodiment, a phrase guessing game may be executed, as described more fully below.

A phrase guessing game may be initialized (operation 704). For example, a phrase may be selected from a phrase database, a timer may be started, and the structure of the phrase (such as the number of words and letters per word in the phrase) may be presented to a user. A test may be performed to determine if a gaming input or event has been received from the work interface module 210, the exercise interface module 212, or if a phrase guess has been entered by a user (operation 708). If an event has been received from the work interface module 210 and/or the exercise interface module 212, the event may be translated to an award class, and an award from the award class may be selected. For example, one or more letters of the phrase may be revealed (operation 712). For example, if an exercise event is received indicating that a class “A” asset be awarded, one or more letters of the phrase that correspond to a class “A” asset may be revealed and the method 700 may proceed with operation 708.

If a phrase guess has been entered by a user, the phrase guess may be compared to the actual phrase (operation 716). A test may be performed to determine if the phrase guess matches the actual phrase (operation 720). If the actual phrase matches the phrase guess, the user may be informed of the match, the timer may be stopped and the time used to complete the game may be displayed to the user (operation 724). The method 700 may then end. If the actual phrase does not match the phrase guess, the user may be informed of the mismatch (operation 728) and the method 700 may proceed to operation 708.

FIG. 8 is a flowchart for an example user interface method 800 for performing a phrase guessing game, in accordance with an example embodiment. In one example embodiment, one or more of the operations of the user interface method 800 may be performed by the user device 104-1.

A user may initiate a phrase guessing game by selecting the “start” radio button 620. In response to the user selecting the “start” radio button 620, a start command may be submitted to, for example, the user device interface module 218 (operation 804). A phrase may be obtained, for example, from the user device interface module 218 (operation 808). The structure of the phrase may be displayed in phrase display area 604 (operation 812). A test may be performed to determine if a guess has been submitted by the user or if one or more letters of the phrase may be revealed (operation 816).

If a user has submitted a guess, the phrase entered in the phrase input field 608 may be submitted to the user device interface module 218 (operation 820). A test may be performed to determine if a response to the guess has been received (operation 824). If a response to the guess has been received and the result indicates a correct guess, the result may be indicated in the guess indicator 616 and the timer may be stopped (operation 828). The method 800 may end.

If a response to the guess has been received and the result indicates an incorrect guess, the result may be indicated in the guess indicator 616 (operation 832) and the method 800 may proceed to operation 816.

If one or more letters of the phrase are to be revealed, the block(s) corresponding to the letter(s) to be revealed are replaced with the corresponding letter (operation 836). The method 800 may proceed with operation 816.

Although certain examples are shown and described here, other variations exist and are within the scope of the invention. It will be appreciated by those of ordinary skill in the art that any arrangement, which is designed or arranged to achieve the same purpose, may be substituted for the specific embodiments shown. This application is intended to cover any adaptations or variations of the example embodiments of the invention described herein. It is intended that this invention be limited only by the claims, and the full scope of equivalents thereof.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network 115 (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

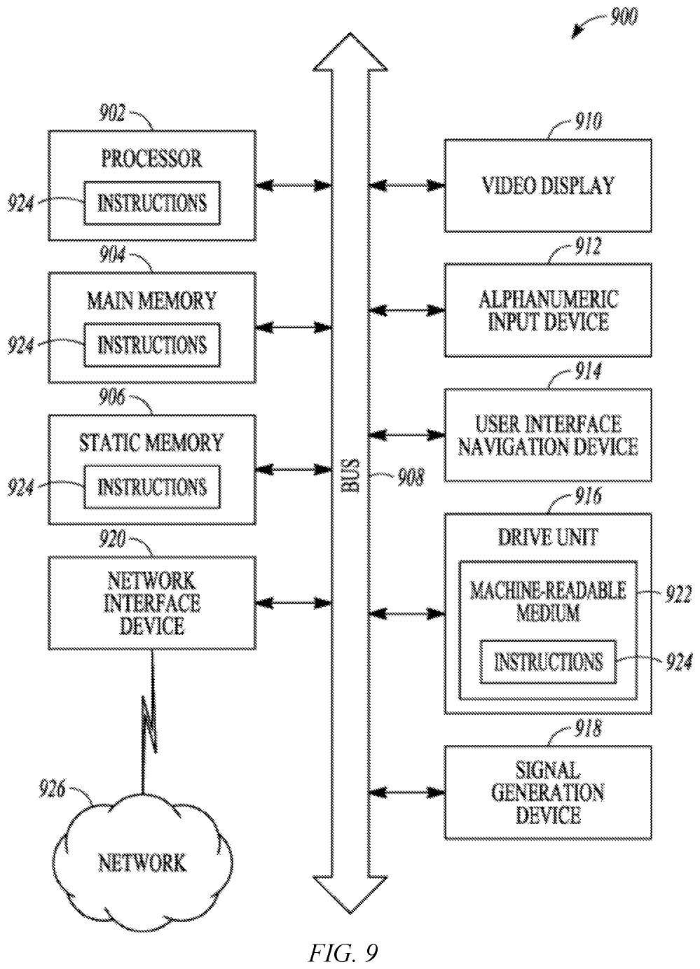

FIG. 9 is a block diagram of a machine within which instructions may be executed for causing the machine to perform any one or more of the methodologies discussed herein. In one example embodiment, the machine may be the user device 104. In one example embodiment, the machine may be the work-driven gaming apparatus 200. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker) and a network interface device 920.

### Machine-Readable Medium

The drive unit 916 includes a machine-readable medium 922 on which is stored one or more sets of instructions 924 and data structures (e.g., software) embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media. Instructions 924 may also reside within the static memory 906.

While the machine-readable medium 922 is shown in an example embodiment to be a single medium, the term “machine-readable medium” may include a single medium or multiple media (e.g., a centralized or distributed database, and/or associated caches and servers) that store the one or more instructions 924 or data structures. The term “machine-readable medium” shall also be taken to include any tangible medium that is capable of storing, encoding or carrying instructions 924 for execution by the machine and that cause the machine to perform any one or more of the methodologies of the present invention, or that is capable of storing, encoding or carrying data structures utilized by or associated with such instructions 924. The term “machine-readable medium” shall accordingly be taken to include, but not be limited to, solid-state memories, and optical and magnetic media. Specific examples of machine-readable media 922 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions 924 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A work-game interface processing module for performing a work-driven game, the work-game interface processing module comprising:
a processor; and
memory to store instructions that, when executed by the processor, cause the processor to perform operations comprising:
obtaining an indication of a completion of a performance of a work event from a work processing system, the work event contributing to a production of a work product;
obtaining an indication of a completion of a performance of an exercise event;
determining a combined value of the work event and the exercise event; and
awarding a gaming asset associated with the work-driven game in a game processing system in response to the indication of the completion of the performance of the work event and the completion of the performance of the exercise event, the gaming asset awarded being based on the combined value.

2. The apparatus of claim 1, wherein the combined value of the work event and the exercise event is inversely proportional to a probability of successfully completing the work event and the exercise event.

3. The apparatus of claim 1, wherein the combined value of the work event and the exercise event is inversely proportional to an amount of time required for completing the work event.

4. The apparatus of claim 1, wherein the combined value of the work event and the exercise event is inversely proportional to an amount of time required for completing the work event and the exercise event in relation to an average time required for completing the work event and the exercise event.

5. The apparatus of claim 1, wherein the combined value of the work event and the exercise event is proportional to a cash value of the work event and the exercise event.

6. The apparatus of claim 1, wherein the gaming asset advances a state of a user during the game toward achieving a gaming objective.

7. The apparatus of claim 1, the operations further comprising selecting a class of the gaming asset based on the combined value.

8. The apparatus of claim 1, the operations further comprising mapping the gaming asset to gaming input.

9. The apparatus of claim 8, the operations further comprising submitting the gaming input to the game processing system.

10. The apparatus of claim 1, the operations further comprising updating the work-driven game based on the gaming asset.

11. The apparatus of claim 1, wherein the exercise event is performed at least partially during the performance of the work event.

12. A method for work-driven gaming, the method comprising:
obtaining an indication of a completion of a performance of a work event from a work processing system, the work event contributing to a production of a work product;
obtaining an indication of a completion of a performance of an exercise event;
determining a combined value of the work event and the exercise event; and
awarding a gaming asset associated with the work-driven game in a game processing system in response to the indication of the completion of the performance of the work event and the completion of the performance of the exercise event, the gaming asset awarded being based on the combined value.

13. The method of claim 12, wherein the combined value of the work event and the exercise event is inversely proportional to an amount of time required for completing the work event.

14. The method of claim 12, wherein the gaming asset advances a state of a user during the game toward achieving a gaming objective.

15. The method of claim 12, the operations further comprising selecting a class of the gaming asset based on the combined value.

16. The method of claim 12, the operations further comprising mapping the gaming asset to gaming input.

17. The apparatus of claim 16, the operations further comprising submitting the gaming input to the game processing system.

18. The method of claim 12, the operations further comprising updating the work-driven game based on the gaming asset.

19. The method of claim 12, wherein the exercise event is performed at least partially during the performance of the work event.

20. A non-transitory computer-readable medium embodying instructions that, when executed by a processor perform operations comprising:
obtaining an indication of a completion of a performance of a work event from a work processing system, the work event contributing to a production of a work product;
obtaining an indication of a completion of a performance of an exercise event;
determining a combined value of the work event and the exercise event; and
awarding a gaming asset associated with the work-driven game in a game processing system in response to the indication of the completion of the performance of the work event and the completion of the performance of the exercise event, the gaming asset awarded being based on the combined value.
